(19) United States
(12) Patent Application Publication
(10) Pub. No.: US 2012/0293320 A1
(43) Pub. Date: Nov. 22, 2012

(54) CALENDAR SYSTEM AND WORKING METHOD FOR THE SYSTEM

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 13/207,674

(22) Filed: Aug. 11, 2011

(30) Foreign Application Priority Data
May 20, 2011 (TW) 100117720

(51) Int. Cl. G08B 1/08

(52) U.S. Cl. 340/522

(57) ABSTRACT

A working method for a calendar system includes: setting information of an event. Storing the information of the event, tracking a location of a user and comparing the location of the user with a location of the event when the deadline of the event is not passed to determine whether a distance between the two locations is greater than a preset distance. Comparing a time at present with a time period when the event can be dealt with to determine whether the event can be dealt with at present if the distance between the location of the user and the location of the event is less than the preset distance. In addition, informing the user to deal with the event if the time at present is in the time period when the event can be dealt with.

### BACKGROUND

1. Technical Field

The present disclosure relates to a calendar system and a working method for calendar system.

2. Description of Related Art

Calendar systems in mobile phones are based on date and time. When the preset date and time is reached, the system informs the users to deal with the appointed event. This is tedious.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic diagram of a calendar system.

FIGS. 2-6 are schematic diagrams of the calendar system of FIG. 1 showing a working environment.

FIG. 7 is a flowchart of an exemplary embodiment of a working method for a calendar system.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

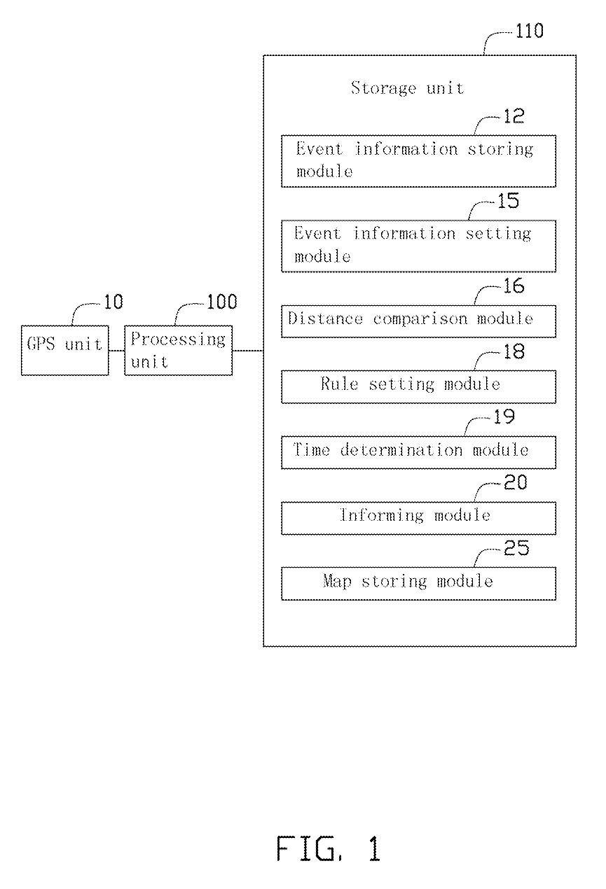

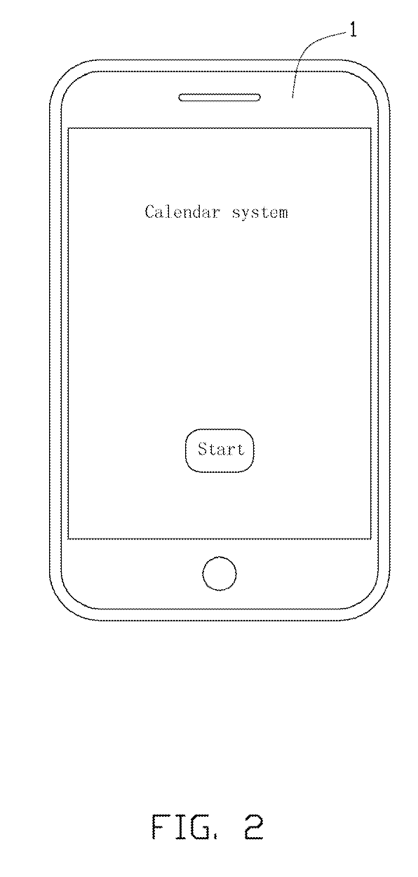

Referring to FIGS. 1 and 2, an exemplary embodiment of a calendar system is set in a handheld device 1, such as a mobile phone. The calendar system includes a global positioning system (GPS) unit 10, a processing unit 100, and a storage unit 110.

The storage unit 110 includes an event information storing module 12, an event information setting module 15, a distance comparison module 16, a rule setting module 18, a time determination module 19, an informing module 20, and a map storing module 25, which may include computer code to be executed by the processing unit 100.

The GPS unit 10 tracks a location of the handheld device 1, namely a location of a user who holds the handheld device 1. In the embodiment, the location of the handheld device 1 can be recorded as longitude and latitude.

The event information setting module 15 sets and modifies information of the event. In the embodiment, the information of the event includes a title of the event, a detail description of the event, a deadline of the event, a time period when the event can be dealt with, and a location of the event. After the information of the event is set, the information is stored in the event information storing module 12. As a matter of convenience, the user can choose a corresponding address on a map stored in the map storing module 25 to set the location of the event.

The distance comparison module 16 compares the location of the user obtained by the GPS unit 10 with the location of the event. When a distance between the two locations is less than a preset distance, the distance comparison module 16 outputs a first control signal to the time determination module 19. The preset distance can be set through the rule setting module 18. In the embodiment, the distance between the two locations may be a straight line distance between the two locations.

The time determination module 19 compares the time at present with the time period of the event to determine whether the user can deal with the event at this time. If the present time is in the time period, the time determination module 19 outputs a second control signal to the informing module 20. The informing module 20 informs the user to deal with the event at this time.

In addition, if before the deadline of the event, the user has not arrived at a location near the location of the event. The distance comparison module 16 determines that the distance between the location of the user and the location of the event is greater than the preset distance, the informing module 20 informs the user to deal with the event when the deadline is reached.

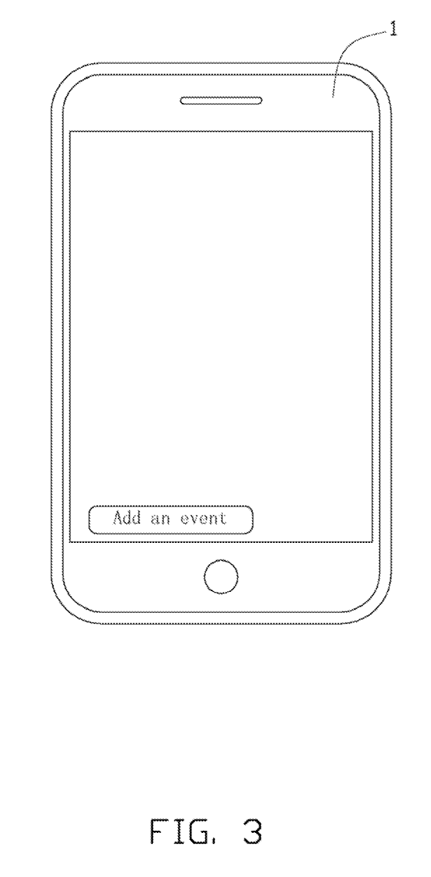

Referring to FIGS. 2-6, when the user starts the calendar system, an interface is displayed on a screen of the handheld device 1 as shown in FIG. 2. After that, the user can set or modify the information of the event (shown as FIG. 3).

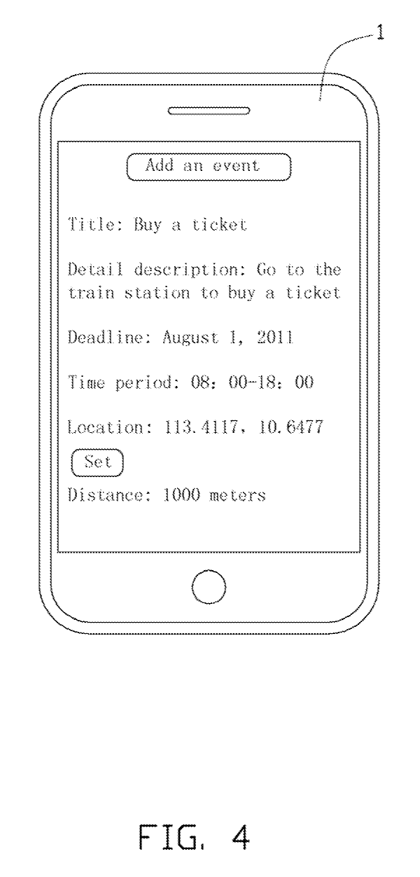

Referring to FIG. 4, the title of the event is “Buy a ticket”. The detail description of the event is “Go to the train station to buy a ticket”. The deadline of the event is “Aug. 1, 2011”. A time period when the event can be dealt with is “08:00-18:00”. The location of the event is “113.4117, 10.6477”. The preset distance is “1000 meters”. In the embodiment, the user presses the “Set” button to show a map on the screen of the handheld device 1, and then chooses the train station on the map to set the location of the event. The information of the event set above is stored in the event information storing module 12.

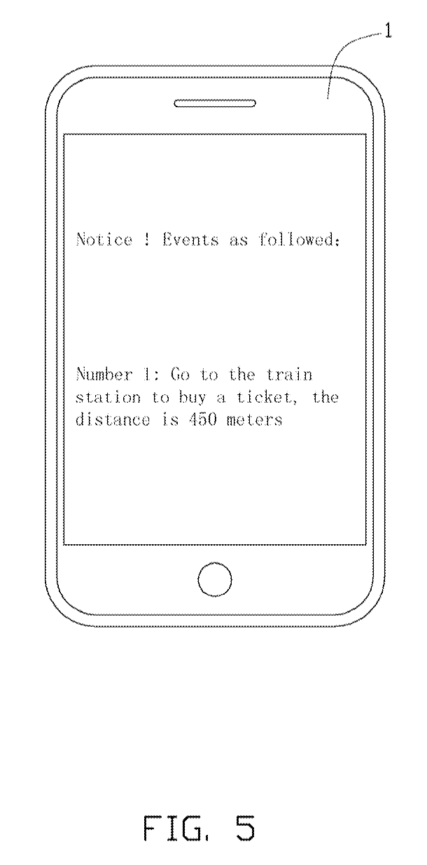

Before the deadline of the event, namely it is Aug. 1, 2011, the GPS unit 10 tracks the location of the user. The distance comparison module 16 compares the location of the user obtained by the GPS unit 10 with the location of the event, namely “113.4117, 10.6447”, to obtain a distance between the two locations. If the distance between the two locations is less than the preset distance, namely 1000 meters, the time determination module 19 compares the time at present (such as 11:00) with the time period when the event can be dealt with, namely “08:00-18:00” to determine whether the user can deal with the event at this time. Obviously, the present time is in the time period. The informing module 20 informs the user to buy a ticket at the train station (shown as FIG. 5).

In FIGS. 2-5, the user sets only one event. In other embodiments, the user can set more than one event. The information of the more than one event is stored in the event information storing module 12.

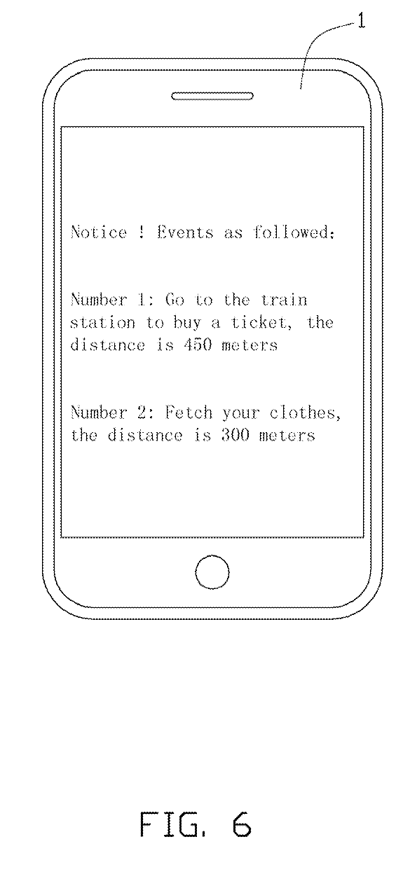

The distance comparison module 16 compares the location of the user obtained by the GPS unit 10 with a location of each unexpired event to determine a distance between the location of the user and the location of each unexpired event. In the embodiment, an event, which has not reached its deadline, is regarded as an unexpired event. If a distance between the two locations is less than the preset distance, the unexpired event is regarded as a nearby event. The time determination module 19 compares the time at present with each time period of the nearby event to determine whether the user can deal with the nearby event at this time. If the time at present is in the time period of the nearby event, the informing module 20 informs the user to deal with the nearby event. Moreover, the informing module 20 informs the location and the time of each event which meets the requirements (as shown in FIG. 6). The user can deal with one of the events at this time.

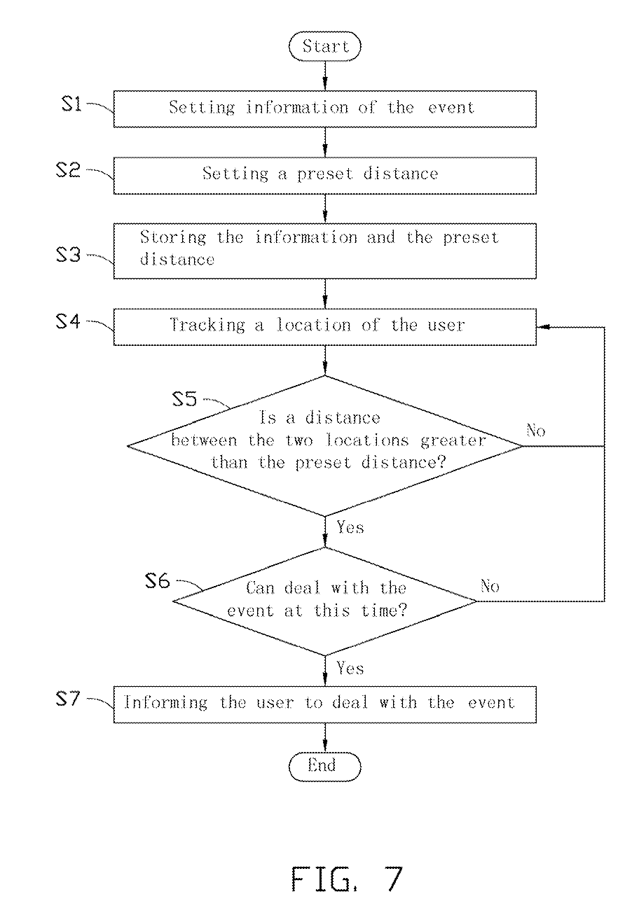

Referring to FIG. 7, an exemplary embodiment of a working method for the calendar system includes the following steps.

In step S1, the information of the event is set or modified by the event information setting module 15. In the embodiment, the information of the event includes a title of the event, a detail description of the event, a deadline of the event, a time period when the event can be dealt with, and a location of the event. In addition, in the embodiment, the location of the event can be set through choosing a corresponding address on a map stored in the map storing module 25.

In step S2, a preset distance is set through the rule setting module 18.

In step S3, the event information storing module 12 stores the information of the event and the preset distance.

In step S4, the GPS unit 10 tracks the location of the user.

In step S5, the distance comparison module 16 compares the location of the user obtained by the GPS unit 10 with location of the event. When a distance between the two locations is less than the preset distance, it flows to step S6. When the distance between the two locations is greater than the preset distance, it returns to step S4. In the embodiment, the distance between the two locations may be a straight line distance between the two locations.

In step S6, the distance comparison module 16 outputs a first control signal to the time determination module 19, and the time determination module 19 compares the time at present with the time period of the event to determine whether the user can deal with the event at this time. If the time at present is in the time period of the event, it flows to step S7. If the time at present is not in the time period of the event, it returns to step S4.

In step S7, the informing module 20 informs the user to deal with the event.

The foregoing description of the exemplary embodiments of the disclosure has been presented only for the purposes of illustration and description and is not intended to be exhaustive or to limit the disclosure to the precise forms disclosed. Many modifications and variations are possible in light of everything above. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A calendar system, the system comprising:
a global positioning system (GPS) unit to track a location of a user;
a processing unit connected to the GPS unit to receive the location; and
a storage unit connected to the processing unit and storing a plurality of programs to be executed by the processing unit, wherein the storage unit comprises:
an event information setting module to set and modify information of an event, wherein the information of the event comprises a title of the event, a deadline of the event, a time period when the event can be dealt with, and a location of the event;
an event information storing module to store the information of the event;
a distance comparison module to compare the location of the user with the location of the event to determine whether a distance between the two locations is greater than a preset distance;
a time determination module to compare a time at present with the time period when the event can be dealt with to determine whether the event can be dealt with at present if the distance between the two locations is less than the preset distance; and
an informing module, wherein when the event can be dealt with at present, the informing module informs the user to deal with the event.

2. The system of claim 1, wherein the storage unit further comprises a rule setting module, to set the preset distance.

3. The system of claim 1, wherein the storage unit further comprises a map storing module, the location of the event is set through choosing a corresponding address on a map stored in the map storing module.

4. The system of claim 1, wherein if the distance comparison module determines that the distance between the location of the user and the location of the event is greater than the preset distance continuously, the informing module informs the user to deal with the event when the deadline is reached.

5. A working method for a calendar system, the method comprising:
setting information of an event, wherein the information of the event comprises a title of the event, a deadline of the event, a time period when can deal with the event, and a location of the event;
storing the information of the event;
tracking a location of a user;
comparing the location of the user with the location of the event when the deadline of the event is not passed to determine whether a distance between the two locations is greater than a preset distance;
comparing a time at present with the time period when the event can be dealt with to determine whether the event can be dealt with at present if the distance between the location of the user and the location of the event is less than the preset distance; and
informing the user to deal with the event if the time at present is in the time period when the event can be dealt with.

6. The method of claim 5, wherein setting the location of the event comprises:
choosing a corresponding address on a map.
